(19) United States
(12) Patent Application Publication
(10) Pub. No.: US 2025/0035853 A1
(43) Pub. Date: Jan. 30, 2025

(54) SILICON PHOTONICS CHIP WITH PLC FOR EVANESCENT COUPLING

(71) Applicant: nEYE Systems, Inc., Berkeley, CA (US)

(72) Inventors: Tae Joon SEOK, El Cerrito, CA (US); Xiaosheng ZHANG, Davis, CA (US); Ming Chiang A. WU, Moraga, CA (US); Noriaki KANEDA, Lafayette, CA (US); Kyungmok KWON, El Cerrito, CA (US)

(21) Appl. No.: 18/786,097

(22) Filed: Jul. 26, 2024

Related U.S. Application Data
(60) Provisional application No. 63/515,651, filed on Jul. 26, 2023.

(51) Int. Cl. G02B 6/30

(52) U.S. Cl. CPC G02B 6/30

(57) ABSTRACT

Photonic integrated circuits (PICs) are provided that include silicon photonic structures such as a network of horizontal and vertical bus waveguides and micro-electro-mechanical-system (MEMS) actuated switching elements configured to selectively couple light between selected horizontal and vertical bus waveguides. The PICs of the present disclosure can be applied or used in a wide variety of fields including but not limited to fiber-optic communication, photonic computing, and light detection and ranging (LiDAR). The PICs can include one or more planar lightwave circuit (PLC) die configured to evanescently couple one or more optical fibers to the plurality of silicon photonics structures.

### PRIORITY CLAIM

This patent application claims priority to U.S. Provisional Patent Application No. 63/515,651, titled “SILICON PHOTONICS CHIP WITH PLC FOR EVANESCENT COUPLING,” and filed on Jul. 26, 2023, which is herein incorporated by reference in its entirety.

### FIELD

The present disclosure details novel MEMS optical circuit switches.

### BACKGROUND

The emergence of data-intensive cloud computing, high-performance computing (HPC), artificial intelligence (AI) and machine learning (ML) systems has led the explosive growth of data traffics in data center networks. Conventional electrical packet switches which support optical networks in present data centers are facing increasing challenges in energy consumption as the required data rate, which is the speed of data transmission, continues to increase. Optical circuit switches require significantly lower power than typical electrical switches and, thus, can solve these energy challenges by offering unlimited bandwidth that is agnostic to the data rate.

Silicon photonics leveraging advanced CMOS foundry manufacturing is a viable technology platform to demonstrate large-scale optical switches. Silicon photonic devices typically employ waveguides formed in a thin silicon-on-insulator (SOI) layer, where a myriad of photonic components are routed by the waveguides to provide a complex functionality. Integrated optical switches implemented on silicon photonics platform, or “silicon photonic switches”, offer high-density integration and low-cost manufacturing.

Low-cost, high bandwidth, low-loss coupling interfaces are required for coupling optical circuit switches with optical fibers in demanding applications such as high-performance computing. Previous devices utilizing MEMS optical switches on silicon substrates have described using glass substrate for packaging silicon photonics chips. The glass substrate includes ion-exchange waveguides to couple light between optical fibers and silicon photonics chips. In these structures, the glass substrate needs to be larger than the silicon photonics chip and needs to mechanically support the silicon photonics chip and the optical fibers, which may not be feasible in practice because of the fragility of glass. In addition, through-glass vias are required to electrically connect the silicon photonics chip to external electronic drivers, which increases the fabrication and packaging complexity.

There is a need in the art for improved coupling between optical fibers and silicon photonics chips.

### SUMMARY OF THE DISCLOSURE

A photonics chip is provided, comprising: a silicon substrate comprising a plurality of silicon photonics structures; one or more optical fibers; and at least one planar lightwave circuit (PLC) die configured to evanescently couple the one or more optical fibers to the plurality of silicon photonics structures.

In some aspects, the plurality of silicon photonics structures comprises bus waveguides and optical switches.

In one aspect, the plurality of silicon photonics structures comprises a network of horizontal and vertical bus waveguides and micro-electro-mechanical-system (MEMS) actuated switching elements configured to selectively couple light between selected horizontal and vertical bus waveguides.

In some aspects, the optical switches comprise micro-electro-mechanical-system (MEMS) actuated switching elements.

In one aspect, the PLC die comprises one or more PLC waveguides corresponding to the one or more optical fibers.

In some aspects, the one or more PLC waveguides are edge coupled to the one or more optical fibers.

In one aspect, the chip includes an index-matching gel applied between the one or more optical fibers and the PLC die.

In another aspect, the chip includes a glass lid disposed on the PLC die.

In one aspect, the at least one PLC die is disposed on at least 2 edges of the silicon substrate.

In some aspects, the at least one PLC die is disposed on at least 4 edges of the silicon substrate.

In one aspect, the at least one PLC die is sized and configured to encapsulate the plurality of silicon photonics structures.

In some aspects, the at least one PLC die is configured to provide evanescent coupling to the one or more optical fibers on up to 4 edges of the silicon substrate.

In other aspects, the at least one PLC die is larger than the silicon substrate.

In some aspects, the at least one PLC die has a cavity configured to accommodate and encapsulate the plurality of silicon photonics structures.

In other aspects, the PLC die is sized and configured to hermetically encapsulate the plurality of silicon photonics structures.

In an additional aspect, the chip includes a complementary metal-oxide-semiconductor CMOS die electrically connected to the plurality of silicon photonics structures to provide electronic control of the plurality of silicon photonics structures.

A photonics chip is provided, comprising: a silicon-on-insulator (SOI) substrate comprising a plurality of SOI bus waveguides and a plurality of micro-electro-mechanical-system (MEMS) actuated switching elements; a plurality of optical fibers; at least one planar lightwave circuit (PLC) die configured to evanescently couple at least one of the plurality of optical fibers to the plurality of SOI bus waveguides; and a glass substrate comprising a plurality of bus waveguides coupled to at least one of the plurality of optical fibers, the glass substrate being vertically aligned with the SOI substrate; wherein the MEMS actuated switching elements are configured to couple light between the SOI bus waveguides on the SOI substrate and the bus waveguides on the glass substrate.

In some aspects, the MEMS actuated switching elements comprise vertical switching elements that move up and down.

In other aspects, the bus waveguides of the glass substrate are edge coupled to at least one of the plurality of optical fibers.

A photonics chip is provided, comprising: a silicon-on-insulator (SOI) substrate comprising a plurality of SOI bus waveguides terminating at inter-layer couplers, and a plurality of micro-electro-mechanical-system (MEMS) actuated switching elements; a plurality of optical fibers; and a glass substrate comprising a plurality of bus waveguides coupled to at least one of the plurality of optical fibers, and further comprising a plurality of coupler waveguides terminating at inter-layer couplers, the coupler waveguides being coupled to at least one of the plurality of optical fibers; wherein the SOI substrate is vertically aligned with the glass substrate such that the inter-layer couplers of the SOI substrate are optically coupled to the inter-layer couplers of the glass substrate; and wherein the MEMS actuated switching elements are configured to couple light between the SOI bus waveguides on the SOI substrate and the bus waveguides on the glass substrate.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1A is a top view of a silicon photonics chip with PLC for evanescent coupling.

FIG. 1B is a side view of a silicon photonics chip with a lidless PLC die and an index matching gel for evanescent coupling between the silicon photonics chip and optical fiber(s).

FIG. 1C is a side view of a silicon photonics chip with a PLC die with a glass lid and an index matching gel for evanescent coupling between the silicon photonics chip and optical fiber(s).

FIG. 2A is a top view of an integrated MEMS optical switch chip with PLC for evanescent coupling.

FIG. 2B is a side view of the MEMS optical switch chip of FIG. 2A.

FIGS. 2C-2D show another embodiment of a MEMS optical switch chip.

FIGS. 3A-3B show embodiments of a MEMS optical switch chip where a PLC die is used for both optical coupling between one or more sets of optical fibers and MEMS device encapsulation.

FIG. 4 illustrates an embodiment where a complementary metal-oxide-semiconductor CMOS die is electrically connected to MEMS structures of the MEMS optical switch chip of FIGS. 3A-3D with through-silicon vias for electronic control of the MEMS optical switches.

FIGS. 5A-5D show an integrated MEMS optical switch chip comprising structures fabricated on two substrates, a glass substrate and a silicon-on-insulator (SOI) substrate.

FIGS. 6A-6D show another embodiment of an integrated MEMS optical switch chip comprising structures fabricated on two substrates, a glass substrate and a silicon-on-insulator (SOI) substrate.

### DETAILED DESCRIPTION

This disclosure provides novel silicon photonics chips or photonic integrated circuits (PICs) that include systems and methods for light coupling between optical fibers and silicon photonics chips (for example, MEMS optical switch chips). Generally, the PICS of the present disclosure are configured to detect, generate, transport, and/or process light. The PICS of the present disclosure can be applied or used in a wide variety of fields including but not limited to fiber-optic communication, photonic computing, and beam steering including light detection and ranging (LiDAR). The proposed PICs can include couplers using a planar lightwave circuit (PLC) or glass waveguide interposers.

Specifically, features of the PICs described in this disclosure can include:
(1) Bonding an individual PLC on any of the edges of the silicon photonics die.
(2) PLC dies with waveguides on the edges and a cavity in the middle. The PLC die can provide both fiber coupling to 1, 2, 3, or 4 edges and encapsulation of the MEMS devices (hermetic or non-hermetic).
(3) Wafer-scale processing of (2). The bonded package can be diced and finished with polished edges.
(4) Electrical interconnects using through-silicon vias on the silicon photonics wafer, and bump-bonded or direct bonding to a CMOS or interposer wafer.
(5) Die-level electrical packaging of (4).
(6) Two-substrate MEMS optical switch with the glass interposer as the top substrate.

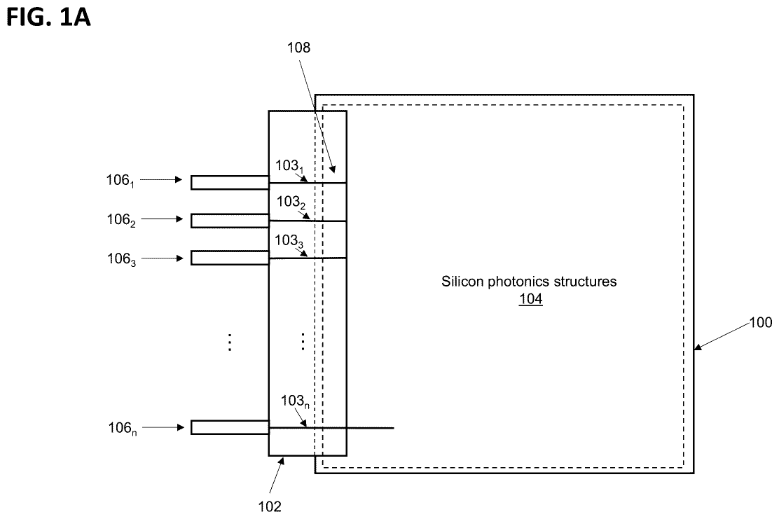

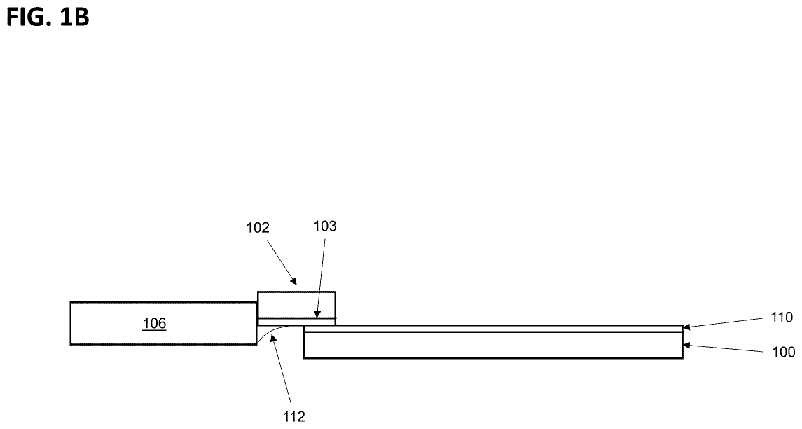

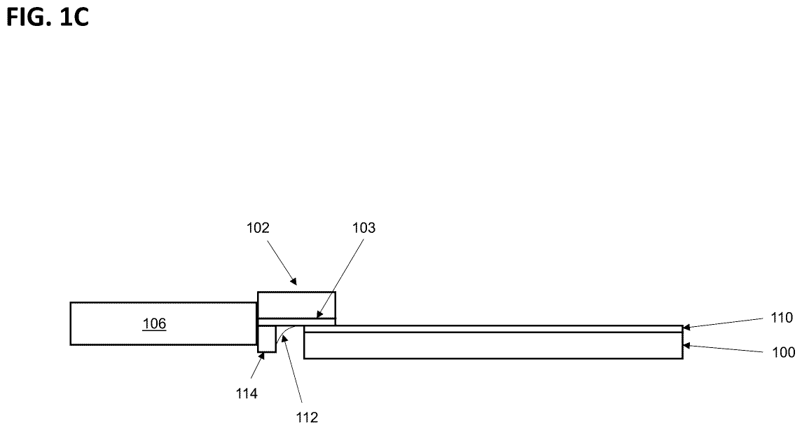

FIGS. 1A-1C show schematics of a silicon photonics chip 100 with a planar lightwave circuit (PLC) die 102 that includes a plurality of PLC waveguides 103 for light coupling between silicon photonics structures 104 and optical fibers 106. The silicon photonics structures 104 can include, but not be limited to, horizontal and/or vertical waveguides and optical switches. In some aspects, the optical switches comprise micro-electro-mechanical-system (MEMS) actuated switching elements to couple light between the waveguides and/or other silicon photonics structures.

The PLC die provides an evanescent coupling region 108 between the optical fibers 106 and the silicon photonics structures 104. In some embodiments, the PLC die 102 may include n number of PLC waveguides 1031 through 103, corresponding to n number of optical fibers 1061 through 106ₙ. The PLC die 102 in this disclosure may be based on a glass substrate or quartz substrate, and may be fabricated by conventional planar lightwave circuit technologies, by ion-exchange technologies, or by other technologies that can define optical waveguides on a glass or quartz substrate.

In the embodiment of FIG. 1A, one end of each PLC waveguide is edge coupled to an optical fiber, and the other end of each PLC waveguide is evanescent coupled to the silicon photonics structures 104 (e.g., to silicon photonics waveguides). The PLC die may also be mechanically bonded to the silicon photonics die.

FIG. 1B is a side view of a silicon photonics chip 100 with a PLC die 102 for evanescent coupling between the chip and optical fiber(s) 106 with PLC waveguides 103 and silicon photonics waveguides 110. In the embodiment shown in FIG. 1B, the PLC die 102 is lid-less, and includes an index-matching gel 112 applied between the optical fiber 106 and the PLC die 102. In another embodiment, shown in FIG. 1C, the PLC die 102 has a glass lid 114, and an index matching gel 112 applied between the glass lid and the PLC die 102. The glass lid can provide mechanical support for fiber attachment. The index matching gel can be used to reduce optical loss at the fiber connection.

Although FIGS. 1A-1C show the PLC die on one edge of the silicon photonics chip, in other embodiments there may be PLC dies on any number of the edges of the silicon photonics chip, including 2, 3, or 4 edges of the silicon photonics chip.

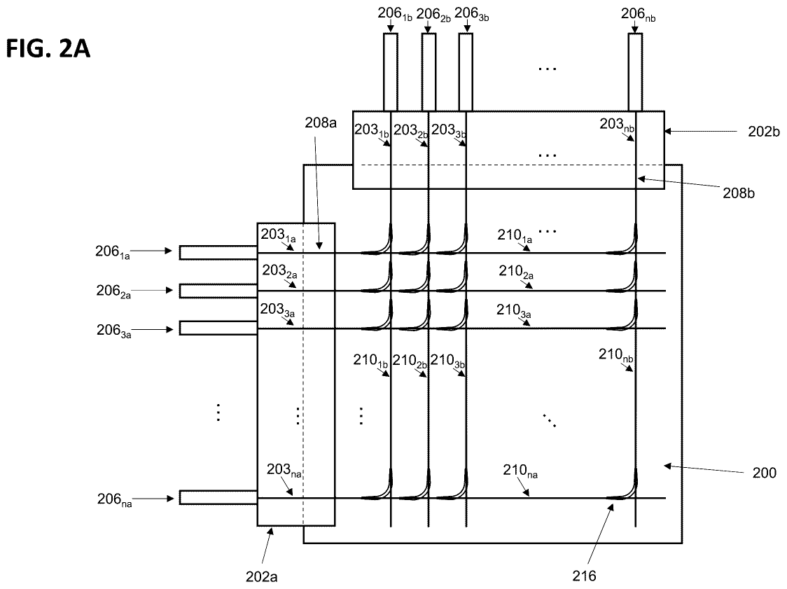

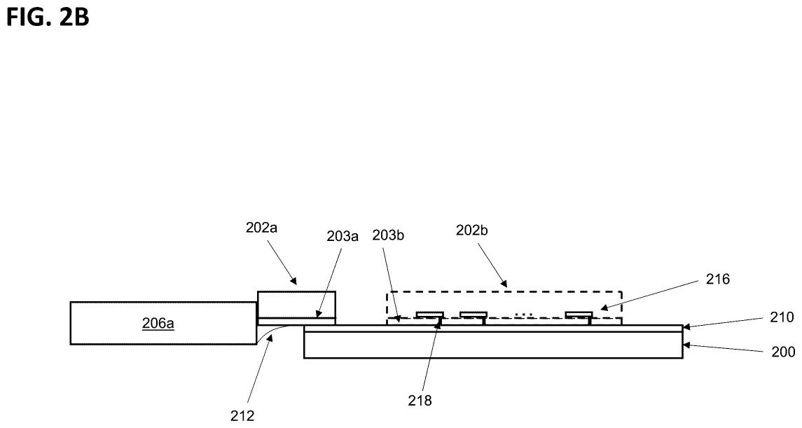

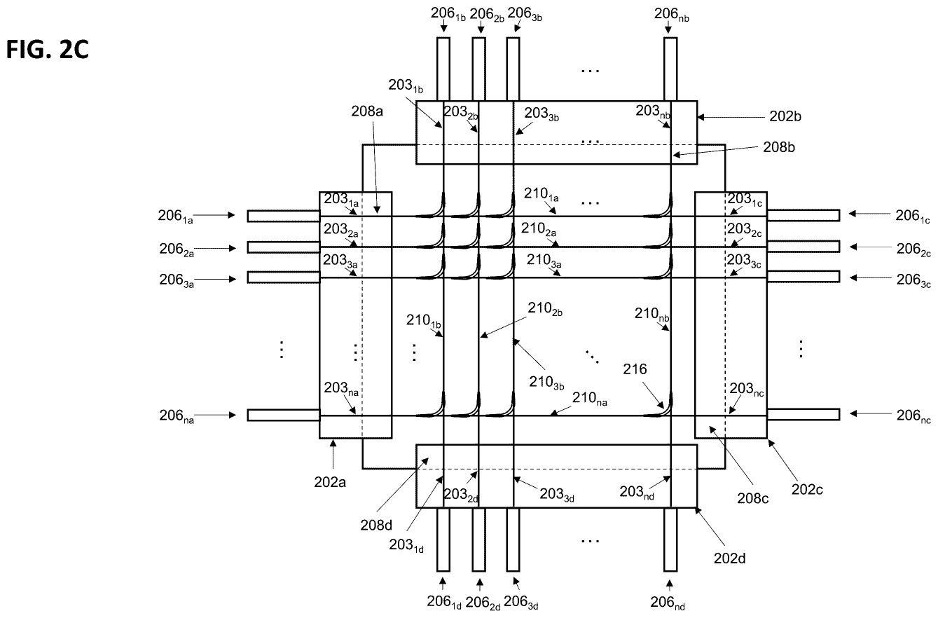

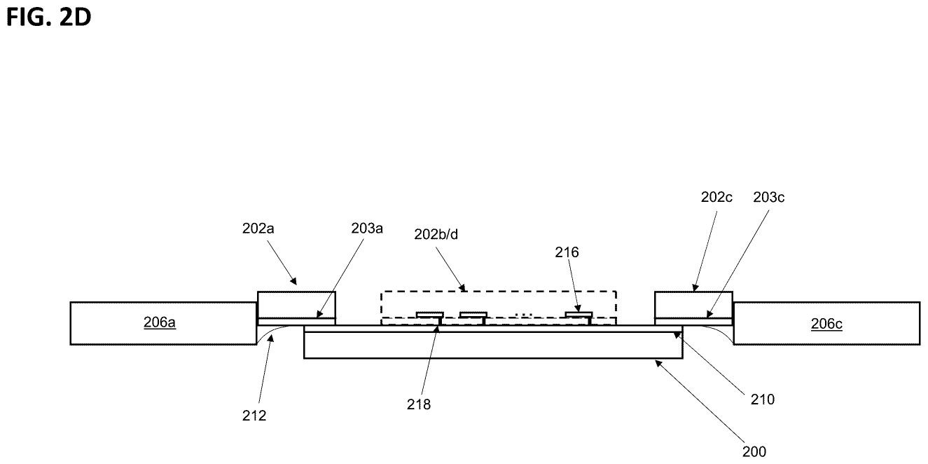

FIGS. 2A-2D show similar embodiments to the structures in FIGS. 1A-1C, but in this example the silicon photonic chip is an integrated MEMS optical switch chip 200. In the top-down view of FIG. 2A, the MEMS optical switch chip 200 has two PLC dies 202a/202b on two edges of the chip, configured to couple light between two sets of optical fibers (206₁ₐ through 206ₙₐ and 206_{1b} through 206_{nb}) and two sets of bus waveguides (210₁ₐ through 210ₙₐ and 210_{1b} through 210_{nb}) via evanescent coupling with two sets of PLC waveguides (203₁ₐ through 203ₙₐ and 203_{1b} through 203_{nb}). Evanescent coupling regions 208a/208b are shown. MEMS structures (such as coupling waveguides and actuators) 216 can be controlled to selectively couple selected rows and columns of the bus waveguides.

FIG. 2B is a side view of MEMS optical switch chip 200 with a PLC dies 202a/202b for evanescent coupling between the chip and optical fiber(s) 206a and a second set of optical fibers (not shown, but corresponding to optical fibers 206_{1b} through 206_{nb} in FIG. 2A) with PLC waveguides 203a/b and silicon photonics waveguides 210. In the embodiment shown in FIG. 2B, the PLC dies are lid-less, and can both include an index-matching gel 112 applied between the optical fiber and the PLC die. Also shown in FIG. 2B is the MEMS structures 216, which in this example can include coupling waveguides and MEMS actuators with anchors 218 coupling the MEMS structures to the MEMS optical switch chip 200.

In the embodiment shown in FIGS. 2C and 2D, the MEMS optical switch die has four PLC dies 202a-202d on four edges, coupling light from optical fibers 206₁ₐ through 206ₙₐ, 206_{1b} through 206_{nb}, 206_{1c} through 206_{nc}, and 206₁ₐ through 206_{nd}, to both ends of the two sets of bus waveguides 210₁ₐ through 210ₙₐ and 210_{1b} through 210_{nb}. Evanescent coupling regions 208a-208d are also shown, along with MEMS structures (such as coupling waveguides and actuators) 216. Although the MEMS optical switch bus waveguides are shown on the same layer in the Figures, they may be fabricated on different layers to avoid physical crossing between the bus waveguides running in two different directions.

FIG. 2D is a side view of the MEMS optical switch chip 200 including all the features previously described, with some features omitted for case of illustration.

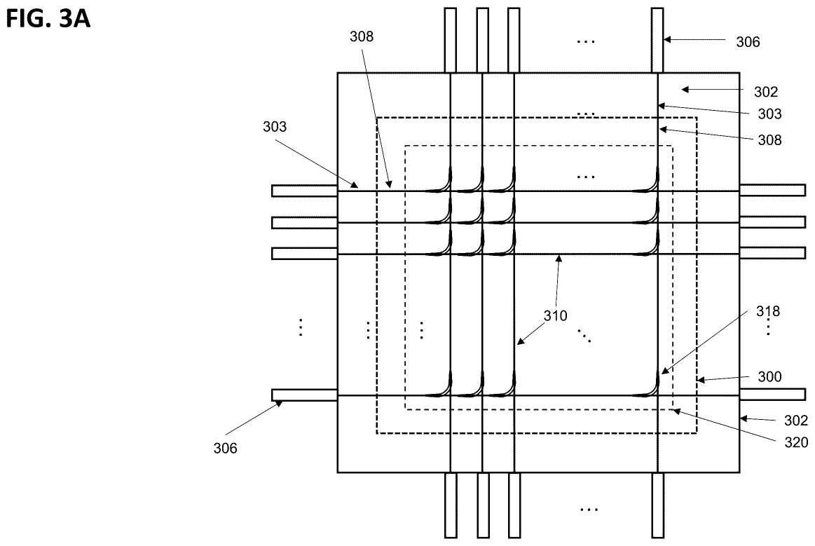

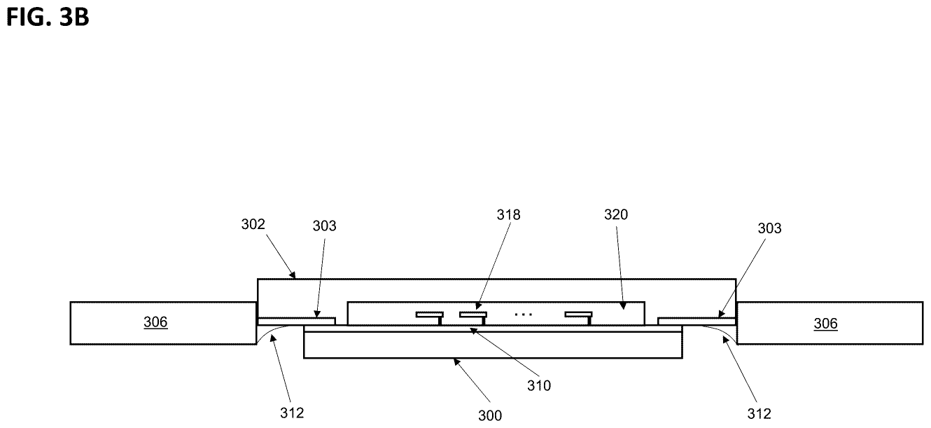

FIGS. 3A-3B show embodiments of a MEMS optical switch chip 300 where a PLC die 302 is used for both optical coupling between one or more sets of optical fibers 306 and MEMS device encapsulation. The PLC die 302 can be slightly larger than the MEMS optical switch chip 300. The PLC die 302 provides fiber coupling to 1, 2, 3, or 4 edges of the MEMS optical switch die (4 edge coupling shown in FIG. 3A). The PLC die has a cavity 320 in the middle sized and configured to accommodate and encapsulate the MEMS structures, where the encapsulation may be hermetic or non-hermetic. The PLC and MEMS optical switch may be assembled together in a die-level process, or they may be first bonded at wafer-level and then diced and edge-polished. As described above, the PLC die can provide evanescent coupling in evanescent coupling region 308 between PLC waveguides 303, bus waveguides 310, and MEMS structures 318 of the MEMS optical switch chip. FIG. 3B is a side view that also shows the index matching gel 312.

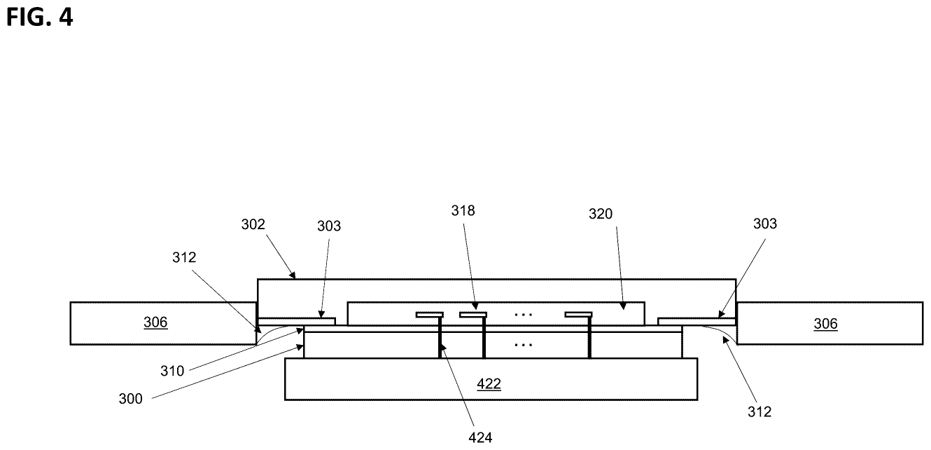

FIG. 4 shows an embodiment where the structure of FIGS. 3A-3B is bonded with a complementary metal-oxide-semiconductor CMOS die 422 and electrically connected to MEMS structures 318 with through-silicon vias 424 for electronic control of the MEMS optical switches. The CMOS and MEMS optical switch may be bonded together in a die-level process or a wafer-level process.

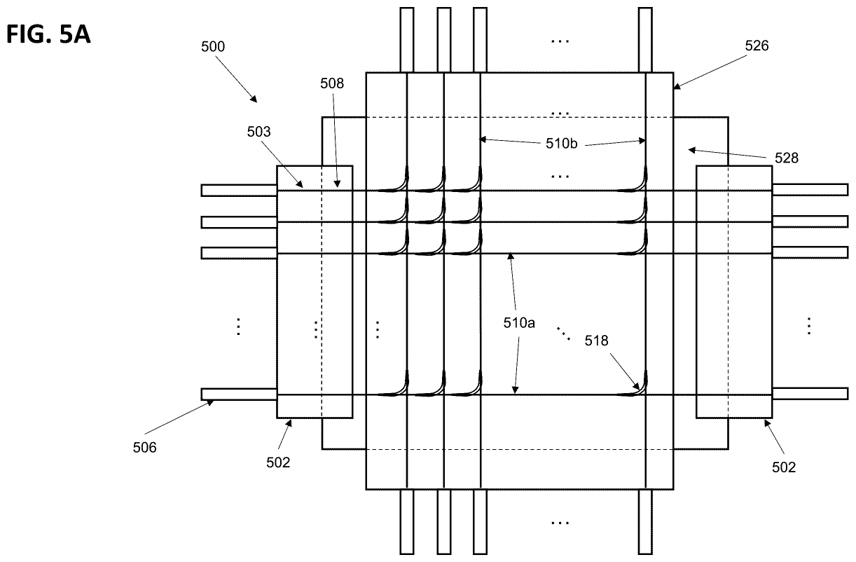

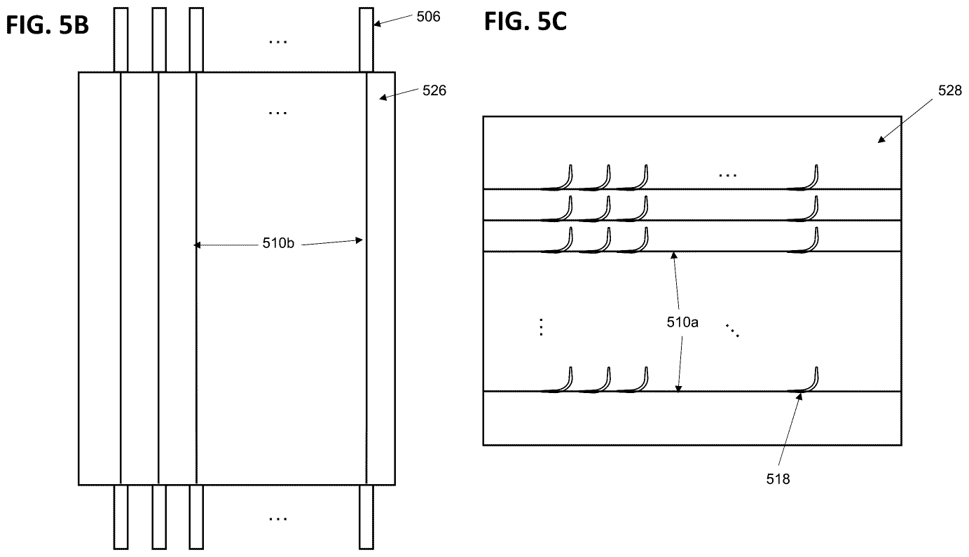

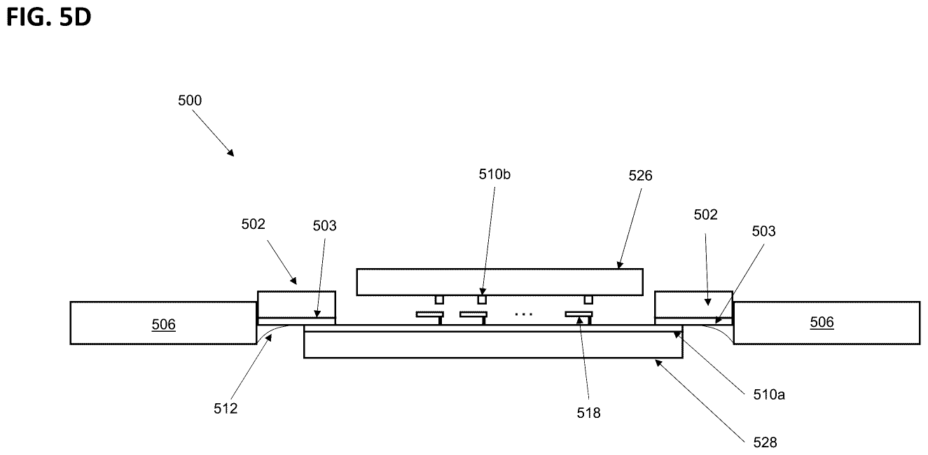

FIGS. 5A-5D show an integrated MEMS optical switch chip 500 comprising structures fabricated on two substrates, a glass substrate 526 and a silicon-on-insulator (SOI) substrate 528. The features described in the embodiments above can also be included in this embodiment, such as PLC dies 502, PLC waveguides 503, optical fibers 506, bus waveguides 510a/b, index matching gel 512, and MEMS structures 518. One layer of SOI bus waveguides 510a and the coupler waveguides and MEMS actuators 518 are fabricated on the SOI substrate 528. Light is evanescently coupled between the SOI bus waveguides 510a and optical fibers 506 by PLC dies 502, similar to the structures shown in the previous figures. The other layer of bus waveguides 510b is directly deposited or patterned on the glass substrate 526. Light is coupled between the glass bus waveguides and optical fibers 506 by edge coupling. After fabricating the structures on the two substrates, the glass substrate can be vertically aligned and bonded on top (or on bottom) of the SOI substrate. The coupler waveguides can couple light between the glass bus waveguides and SOI bus waveguides when the corresponding MEMS actuators are turned on. The MEMS actuator can be a seesaw type or PZT bimorph that moves both up and down. FIG. 5D is a side view of the MEMS optical switch chip 500 of FIGS. 5A-5C. While the embodiment of FIGS. 5A-5D shows 4 sets of optical fibers and two PLC dies, it should be understood that other embodiments may include only 2 sets of optical fibers and one PLC die.

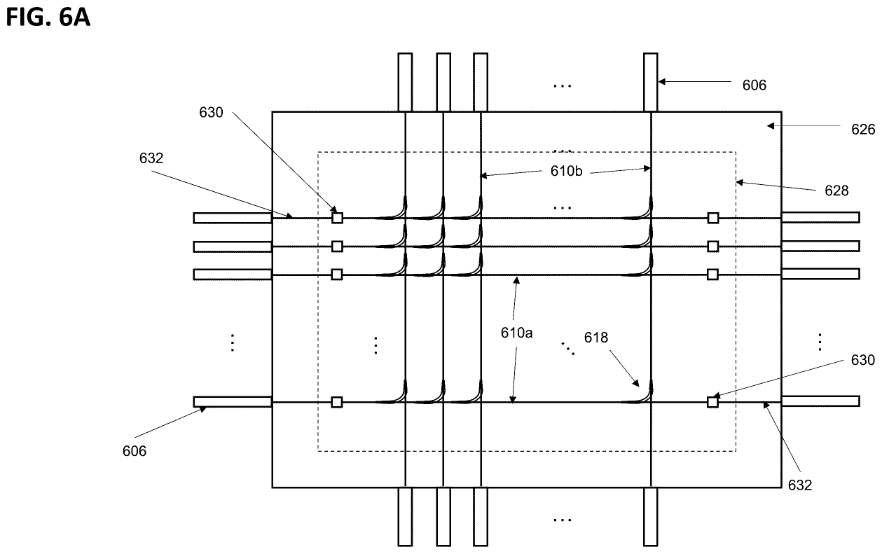

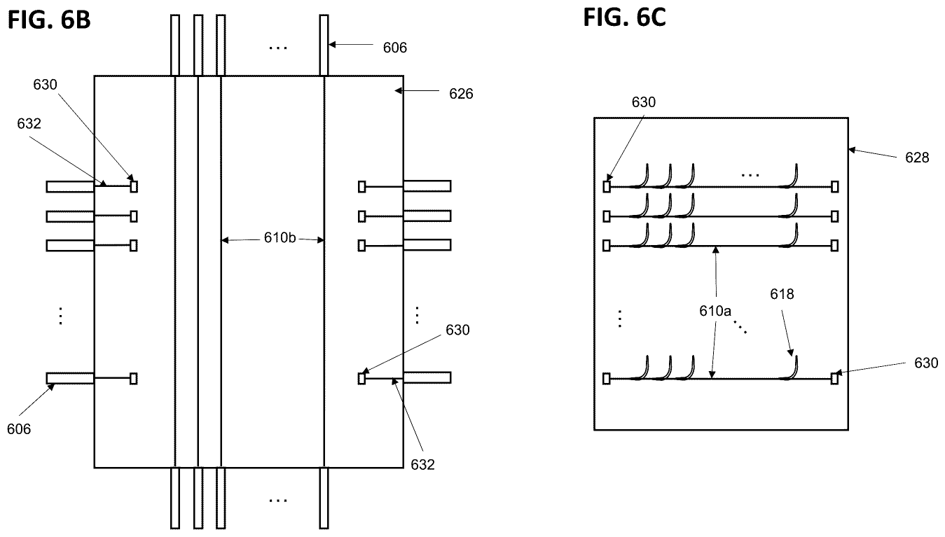

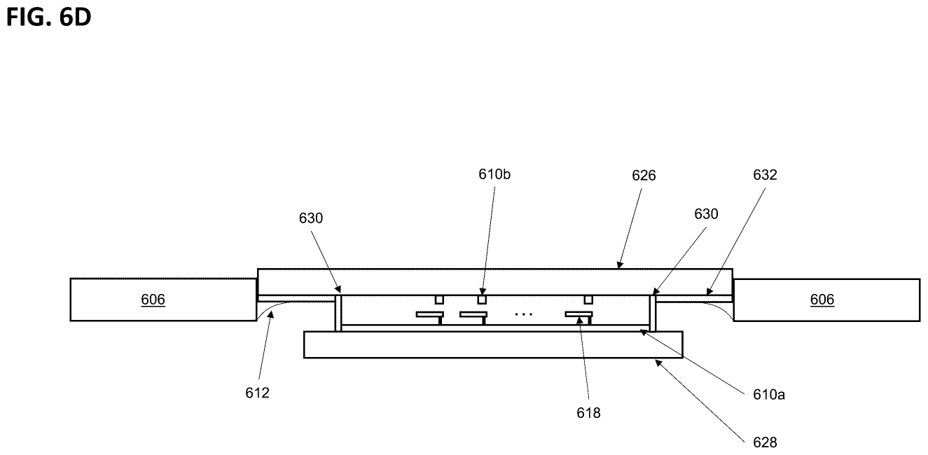

FIGS. 6A-6C show another embodiment of an integrated MEMS optical switch chip 600 comprising structures fabricated on two substrates, a glass substrate 626 and a silicon-on-insulator (SOI) substrate 628. Some features described in the embodiments above can also be included in this embodiment, such as optical fibers 506, bus waveguides 610a/b, index matching gel 612, and MEMS structures 618. One layer of bus waveguides 610a, coupler waveguides 630, and MEMS actuators 618 are fabricated on the SOI substrate 628. The other layer of bus waveguides 610b is directly deposited or patterned on the glass substrate 626. The glass substrate also includes a plurality of coupler waveguides 632 terminating at inter-layer couplers 630. Light is coupled between the glass bus waveguides 610b and optical fibers 606 by edge coupling. In this embodiment, the bus waveguides 610a on the SOI substrate 628 are connected to coupler waveguides 632 on the glass substrate via inter-layer couplers 630. The inter-layer couplers may be optical switches connecting two layers, coupler waveguide connecting two layers, a pair of tapered waveguides on the two layers, or other structures. After fabricating the structures on the two substrates, the glass substrate is aligned and bonded on top of the SOI substrate such that the inter-layer couplers of the SOI substrate align with the inter-layer couplers of the glass substrate. The coupler waveguides 632 can couple light between the glass bus waveguides 610b and SOI bus waveguides 610a when the corresponding MEMS actuators are turned on. The actuator can be the seesaw type or PZT bimorph that moves both up and down.

The disclosure above provides a number of advantages over prior techniques. For example, the PLC and optical fiber can be designed to have a similar refractive index, therefore the optical mode profiles in the optical fiber and in the PLC waveguide can be well matched by designing the PLC waveguide shape and size to achieve a very low edge coupling loss.

Evanescent coupling is used to couple light between the PLC and silicon photonics waveguides. The two waveguides are placed close to each other, within the range of the evanescent field of the optical mode. Each waveguide can include MEMS structures so light can be selectively coupled from one waveguide to the other with low loss while propagating.

The PLC die and silicon photonics die may be bonded together by index-matching epoxy, as described above.

The silicon photonics die and the CMOS die may be bonded together with bump bonding or direct bonding technologies.

Specifically, points of novelty provided herein include:

PLC dies for light coupling between integrated MEMS optical switch chip and optical fibers.

PLC dies for both optical coupling and MEMS encapsulation.

A two-substrate MEMS optical switch with the glass interposer as the top substrate.

The PLC dies can provide low optical coupling loss between optical fibers and silicon photonics waveguides, so the overall insertion loss of the MEMS optical switch can be low.

The PLC to silicon photonics waveguide evanescent coupling has a larger fabrication error tolerance. The coupling loss can be kept low even with some waveguide geometric errors after fabrication.

The PLC die as a MEMS encapsulation can protect the MEMS device from external damage or harsh environments.

In some implementations, due to pitch reduction of the optical fibers, the glass substrate can be larger than the SOI substrate.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

What is claimed is:

1. A photonics chip, comprising:
a silicon substrate comprising a plurality of silicon photonics structures;
one or more optical fibers; and
at least one planar lightwave circuit (PLC) die configured to evanescently couple the one or more optical fibers to the plurality of silicon photonics structures.

2. The chip of claim 1, wherein the plurality of silicon photonics structures comprises bus waveguides and optical switches.

3. The chip of claim 1, wherein the plurality of silicon photonics structures comprises a network of horizontal and vertical bus waveguides and micro-electro-mechanical-system (MEMS) actuated switching elements configured to selectively couple light between selected horizontal and vertical bus waveguides.

4. The chip of claim 2, wherein the optical switches comprise micro-electro-mechanical-system (MEMS) actuated switching elements.

5. The chip of claim 1, wherein the PLC die comprises one or more PLC waveguides corresponding to the one or more optical fibers.

6. The chip of claim 5, wherein the one or more PLC waveguides are edge coupled to the one or more optical fibers.

7. The chip of claim 1, further comprising an index-matching gel applied between the one or more optical fibers and the PLC die.

8. The chip of claim 1, further comprising a glass lid disposed on the PLC die.

9. The chip of claim 1, wherein the at least one PLC die is disposed on at least 2 edges of the silicon substrate.

10. The chip of claim 1, wherein the at least one PLC die is disposed on at least 4 edges of the silicon substrate.

11. The chip of claim 1, wherein the at least one PLC die is sized and configured to encapsulate the plurality of silicon photonics structures.

12. The chip of claim 11, wherein the at least one PLC die is configured to provide evanescent coupling to the one or more optical fibers on up to 4 edges of the silicon substrate.

13. The chip of claim 11, wherein the at least one PLC die is larger than the silicon substrate.

14. The chip of claim 11, wherein the at least one PLC die has a cavity configured to accommodate and encapsulate the plurality of silicon photonics structures.

15. The chip of claim 11, wherein the PLC die is sized and configured to hermetically encapsulate the plurality of silicon photonics structures.

16. The chip of claim 11, further comprising a complementary metal-oxide-semiconductor CMOS die electrically connected to the plurality of silicon photonics structures to provide electronic control of the plurality of silicon photonics structures.

17. A photonics chip, comprising:
a silicon-on-insulator (SOI) substrate comprising a plurality of SOI bus waveguides and a plurality of micro-electro-mechanical-system (MEMS) actuated switching elements;
a plurality of optical fibers;
at least one planar lightwave circuit (PLC) die configured to evanescently couple at least one of the plurality of optical fibers to the plurality of SOI bus waveguides; and
a glass substrate comprising a plurality of bus waveguides coupled to at least one of the plurality of optical fibers, the glass substrate being vertically aligned with the SOI substrate;
wherein the MEMS actuated switching elements are configured to couple light between the SOI bus waveguides on the SOI substrate and the bus waveguides on the glass substrate.

18. The chip of claim 17, wherein the MEMS actuated switching elements comprise vertical switching elements that move up and down.

19. The chip of claim 17, wherein the bus waveguides of the glass substrate are edge coupled to at least one of the plurality of optical fibers.

20. A photonics chip, comprising:
a silicon-on-insulator (SOI) substrate comprising a plurality of SOI bus waveguides terminating at inter-layer couplers, and a plurality of micro-electro-mechanical-system (MEMS) actuated switching elements;
a plurality of optical fibers; and
a glass substrate comprising a plurality of bus waveguides coupled to at least one of the plurality of optical fibers, and further comprising a plurality of coupler waveguides terminating at inter-layer couplers, the coupler waveguides being coupled to at least one of the plurality of optical fibers;
wherein the SOI substrate is vertically aligned with the glass substrate such that the inter-layer couplers of the SOI substrate are optically coupled to the inter-layer couplers of the glass substrate; and
wherein the MEMS actuated switching elements are configured to couple light between the SOI bus waveguides on the SOI substrate and the bus waveguides on the glass substrate.
